(19) United States
(12) Patent Application Publication
(10) Pub. No.: US 2024/0357283 A1
(43) Pub. Date: Oct. 24, 2024

(54) Speaker

(71) Applicants: Foster Electric Company, Limited, Tokyo (JP); Denso Corporation, Aichi (JP)

(72) Inventors: Tomohisa Yoshida, Akishima-shi, Tokyo (JP); Souta Sumi, Akishima-shi, Tokyo (JP)

(21) Appl. No.: 18/684,321

(22) PCT Filed: Sep. 1, 2022
(86) PCT No.: PCT/JP2022/033025

§ 371 Date: Feb. 16, 2024

(30) Foreign Application Priority Data
Sep. 2, 2021 (JP) 2021-143241

(51) Int. Cl. H04R 1/28; B60R 11/00; B60R 11/02; H04R 1/02

(52) U.S. Cl. CPC H04R 1/2896; B60R 11/0217; H04R 1/025; B60R 2011/0005; H04R 2201/029; H04R 2499/13

(57) ABSTRACT

A speaker includes a speaker unit and a holding member, the holding member having a holding portion, an attachment overhang portion, and a rear-side cavity forming portion. The holding portion includes an open-side end portion of the holding member and holds the speaker unit. The attachment overhang portion includes an affixed portion that is configured to be fixed to an attachment target, and a connecting portion that connects the open-side end portion and the affixed portion. The rear-side cavity forming portion is formed continuously with the holding portion and forms a cavity at a rear surface side of the speaker unit. An elastic portion that is formed from a first material, which is an elastic material, is provided at least at the connecting portion of the attachment overhang portion, and a rigid portion that is formed from a second material, which is harder than the first material, is provided at least at the rear-side cavity forming portion, and a rigidity of the rear-side cavity forming portion is higher than a rigidity of the connecting portion.

### TECHNICAL FIELD

The present invention relates to a speaker.

### BACKGROUND ART

Japanese Patent Application Laid-Open (JP-A) No. 2005-20292 discloses a speaker device in which a speaker unit is attached to a door inner panel (attachment target) of a vehicle. In this speaker device, the insulator that attaches the frame of the speaker unit to the door inner panel has an elastic member, and the elastic member absorbs vibration transmitted from the speaker unit to the door inner panel.

### SUMMARY OF THE INVENTION

### Problem to be Solved by the Invention

However, in the technology described in the above publication, a number of elastic members which is equal to the number of insulators is required, which increases the number of parts and complicates the assembly work. In order to solve such a problem, for example, the countermeasures of providing a case-shaped holding member that accommodates and holds the speaker unit, and the holding member being formed from an elastic material and attached to an attachment target may be considered; however, if such countermeasures are taken, the rigidity of the holding member is low, and the sound pressure of the sound output from the speaker unit is lowered.

In consideration of the above facts, the present disclosure provides a speaker capable of achieving both ensuring of sound pressure and reduction of vibration transmitted to an attachment target, while suppressing the number of parts.

### Means for Solving the Problem

A speaker according to a first aspect of the present disclosure includes a speaker unit and a holding member that holds the speaker unit and that is configured to be attached to an attachment target. The holding member includes: a holding portion that configures an open-side portion of the holding member, the holding portion includes an open-side end portion, and holds an outer peripheral portion of the speaker unit; an attachment overhang portion that overhangs outward from the open-side end portion of the holding portion, and the attachment overhang portion includes an affixed portion that is configured to be fixed to the attachment target and a connecting portion that connects the open-side end portion of the holding portion and the affixed portion; and a rear-side cavity forming portion that is formed continuously with the holding portion, the rear-side cavity forming portion forms a cavity at a rear surface side of the speaker unit. An elastic portion that is formed from a first material, which is an elastic material, is provided at least at the connecting portion of the attachment overhang portion, and a rigid portion that is formed from a second material, which is harder than the first material, is provided at least at the rear-side cavity forming portion, such that a rigidity of the rear-side cavity forming portion is higher than a rigidity of the connecting portion.

According to the above-described configuration, the speaker includes the speaker unit and the holding member that holds the speaker unit, and the speaker unit is attached to an attachment target of another member via the holding member. The holding portion of the holding member configures the open-side portion of the holding member, the holding portion includes the open-side end portion of the holding member and holds the outer peripheral portion of the speaker unit. The attachment overhang portion of the holding member overhangs outward from the open-side end portion of the holding portion, and includes the affixed portion that is configured to be fixed to the attachment target and the connecting portion that connects the open-side end portion of the holding portion and the affixed portion. The rear-side cavity forming portion at the holding member is formed continuously with the holding portion and forms a cavity at a rear surface side of the speaker unit.

The elastic portion that is formed from a first material, which is an elastic material, is provided at least at the connecting portion of the attachment overhang portion. Therefore, when vibration of the speaker unit during audio output is transmitted via the holding member to the attachment target of the holding member, the vibration is absorbed by at least the elastic portion provided at the connecting portion. Since vibration is absorbed by part of the holding member in this manner, the number of parts can be reduced. Further, in the present disclosure, by at least the rear-side cavity forming portion being provided with the rigid portion that is formed of the second material, which is harder than the first material, the rear-side cavity forming portion has a higher rigidity than the rigidity of the connecting portion. Due thereto, since the stiffness of the air in the cavity at the rear surface side of the speaker unit can be increased, absorption of vibration energy of the speaker unit is suppressed and sound pressure attenuation is suppressed.

A speaker according to a second aspect of the present disclosure is the configuration according to the first aspect, wherein the elastic portion is provided at an area that includes the open-side end portion of the holding portion; and the open-side end portion of the holding portion includes a front-side contact portion that extends to an inner side of an opening of the holding member and that contacts a front-side outer peripheral portion of the speaker unit.

According to the above-described configuration, since the front-side contact portion of the elastic open-side end portion of the holding portion is in contact with the front-side outer peripheral portion of the speaker unit, sound leakage from the outer peripheral side of the speaker unit is effectively reduced by the front-side contact portion.

A speaker according to a third aspect of the present disclosure is the configuration according to the first aspect or the second aspect, wherein a rigidity reducing portion, which reduces the rigidity of the connecting portion in an axial direction of the speaker unit, is formed at the connecting portion.

According to the above-described configuration, when vibration of the speaker unit during audio output is transmitted via the holding member to the attachment target of the holding member, the connecting portion elastically deforms, thereby absorbing the vibration.

A speaker according to a fourth aspect of the present disclosure is the configuration according to any one of the first aspect to the third aspect, wherein: the elastic portion is provided at an area that includes a portion that configures an inner surface side of the holding portion; the inner surface side of the holding portion contacts an outer peripheral surface of the speaker unit; and a portion, at an outer surface side with respect to a portion that configures the inner surface side of the holding portion, includes the rigid portion.

According to the above-described configuration, the inner surface of the holding portion is in contact with the outer peripheral surface of the speaker unit, the portion that configures an inner surface side of the holding portion is formed from a first material, which is an elastic material, and a portion that is formed from a second material, which is harder than the first material, is included at the portion at the outer surface side with respect to the portion that configures the inner surface side of the holding portion. Therefore, the contact between the inner surface of the holding portion and the outer peripheral portion of the speaker unit is improved, and sound leakage from the outer peripheral side of the speaker unit is suppressed.

A speaker according to a fifth aspect of the present disclosure is the configuration according to any one of the first aspect to the fourth aspect, wherein: the elastic portion is provided at a portion that integrally configures at least the connecting portion of the attachment overhang portion and part of the holding portion; the rigid portion is provided at a portion that integrally configures another part of the holding portion and the rear-side cavity forming portion; and the elastic portion and the rigid portion are provided with concave-convex fitting portions that are formed in an axial direction of the speaker unit such that the concave-convex fitting portions fit together at boundary portions of the elastic portion and the rigid portion.

According to the above-described configuration, the elastic portion is provided at the portion that integrally configures at least the connecting portion of the attachment overhang portion and part of the holding portion. In addition, since the rigid portion is provided at the portion that integrally configures another part of the holding portion and the rear-side cavity forming portion, reduction of the stiffness of the air in the cavity at the rear surface side of the speaker unit due to the elastic portion can be suppressed. The elastic portion and the rigid portion are provided with concave-convex fitting portions that are formed in an axial direction of the speaker unit such that the concave-convex fitting portions fit together at boundary portions of the elastic portion and the rigid portion. Therefore, it is possible to improve the strength of bonding of the boundary portion between the elastic portion and the rigid portion.

A speaker according to a sixth aspect of the present disclosure is the configuration according to any one of the first aspect to the fifth aspect, wherein: at least part of the affixed portion is formed from a material that is harder than the first material.

According to the above-described configuration, the attachment strength and the attachment accuracy of the affixed portion with respect to the attachment target are improved.

A speaker according to a seventh aspect of the present disclosure is the configuration according to any one of the first aspect to the sixth aspect, wherein: the rigid portion is provided at an area that includes at least part of the holding portion; and an extension portion, which extends from a portion that configures the rigid portion at the holding portion and which is part of the rigid portion, is provided adjacent to the elastic portion at the attachment overhang portion.

According to the above-described configuration, since the extension portion is provided as part of the rigid portion, it is possible to improve the strength of bonding between the rigid portion and the elastic portion at a region from the holding portion to the attachment overhang portion.

### Effect of the Invention

As described above, according to the speaker of the present disclosure, it is possible to achieve both ensuring of sound pressure and reduction of vibration transmitted to an attachment target, while suppressing the number of parts.

### BRIEF DESCRIPTION OF THE DRAWINGS

FIG. 1 is a cross-sectional view illustrating a simplified overall configuration in which a speaker according to a first exemplary embodiment is installed at a meter device.

FIG. 2 is a perspective view illustrating the holding member of FIG. 1, as viewed obliquely from the front side.

FIG. 3 is an enlarged cross-sectional view illustrating a state along the line 3-3 in FIG. 2.

FIG. 4 is a perspective view illustrating a holding member to be tested, as viewed obliquely from the rear side.

FIG. 5 is a graph comparing sound pressures measured at predetermined positions on the front side of the speaker.

FIG. 6 is a graph comparing vibration accelerations measured at an attachment target.

FIG. 7 is a cross-sectional view illustrating a simplified overall configuration in which a speaker according to a second exemplary embodiment is installed at a meter device.

FIG. 8 is a perspective view illustrating the holding member of FIG. 7, as viewed obliquely from the front side.

FIG. 9 is an enlarged cross-sectional view illustrating a state along the line 9-9 in FIG. 8.

FIG. 10 is a perspective view of a cross-section illustrating s half potion of a holding member applied to a speaker according to a third exemplary embodiment.

FIG. 11 is a perspective view illustrating a skeleton portion provided at the holding member of FIG. 10.

FIG. 12 is a front view illustrating a holding member applied to a speaker according to a fourth exemplary embodiment.

FIG. 13 is a perspective view illustrating a holding member applied to a speaker according to a fifth exemplary embodiment.

FIG. 14 is an exploded perspective view illustrating an exploded state of an elastic portion and a rigid portion of the holding member of FIG. 13.

FIG. 15A is an enlarged cross-sectional view illustrating a state along the line 15A-15A in FIG. 13.

FIG. 15B is an enlarged cross-sectional view illustrating a state along the line 15B-15B in FIG. 13.

FIG. 16 is a cross-sectional view illustrating a part of a holding member that is applied to a speaker according to a sixth exemplary embodiment.

FIG. 17 is a perspective view illustrating another second component portion that can be disposed in place of the second component portion of the affixed portion of FIG. 16.

FIG. 18 is a perspective view illustrating still another second component portion that can be disposed in place of the second component portion of the affixed portion of FIG. 16.

FIG. 19 is a cross-sectional view illustrating a part of a holding member that is applied to a speaker according to a seventh exemplary embodiment. This corresponds to a cross-sectional view of a state along the line 19L-19L in FIG. 20.

FIG. 20 is a cross-sectional view illustrating a state along the line 20L-20L in FIG. 19.

### MODE FOR CARRYING OUT THE INVENTION

### First Exemplary Embodiment

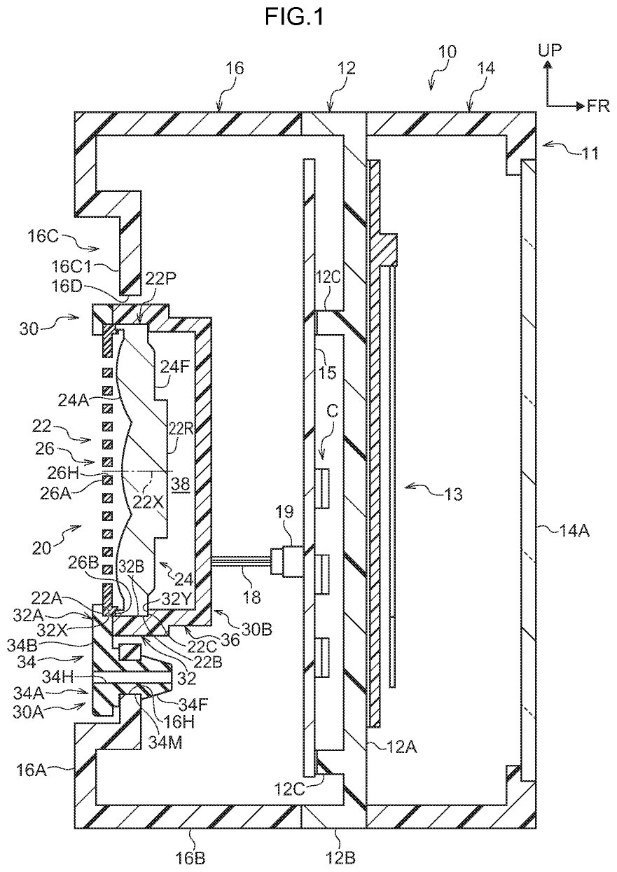

A speaker 20 according to a first exemplary embodiment of the present disclosure will be described with reference to FIG. 1 to FIG. 6. As an example, the speaker 20 is installed at a meter device 10 that is installed at a vehicle. In FIG. 1, for convenience of explanation, the arrow FR indicates a front side of a meter device, which is the side toward which a meter display 13 of the meter device 10 faces, and the arrow UP indicates an upper side of the meter device.

### (Overall Configuration of Meter Device)

The meter device 10 illustrated in FIG. 1 is installed at an instrument panel of a vehicle (not shown). The meter device 10 is disposed in front of a driver and includes a case body 11. The case body 11 is configured by a meter case 12 that is arranged in a middle portion in a front-rear direction of the case body 11, a front case 14 that is arranged at a device front side of the meter case 12, and a rear case 16 that is arranged at a device rear side of the meter case 12.

The meter case 12 is formed in a box shape that is open to the device rear side, and includes a front wall portion 12A, a plate thickness direction of the front wall portion 12A being the front-rear direction, and side wall portions 12B that are respectively erected from each peripheral edge of the front wall portion 12A toward the device rear side. The meter display 13, which displays measured values of various measuring devices installed at the vehicle, is provided at the surface at the device front side of the front wall portion 12A. The meter display 13 is configured to be visible to the driver inside the vehicle through a transparent window portion 14A that is provided at the front case 14.

At a rear surface of the front wall portion 12A of the meter case 12, board support portions 12C are erected toward the device rear side. The board support portions 12C support a meter board 15. A control device (not shown) that receives signals from various measuring devices installed at the vehicle is installed at the meter board 15. Further, the meter board 15 is disposed facing the speaker 20 which is described below. Wiring 18 that extends from the speaker 20 is connected to the meter board 15 via a connector 19, and electronic components C that are necessary for controlling the speaker 20 are mounted at the meter board 15.

The rear case 16 is formed in a box shape that is open to the device front side, and includes a rear wall portion 16A, a plate thickness direction of the rear wall portion 16A being the front-rear direction, and side wall portions 16B that are respectively erected from each peripheral edge of the rear wall portion 16A toward the device front side. A housing recess portion 16C, which is recessed toward an inner side of the rear case 16, is formed at the rear wall portion 16A. Further, a substantially circular opening 16D is formed through a central portion of a recessed bottom wall portion 16C1 of the housing recess portion 16C. Moreover, an attachment hole 16H is formed through the recessed bottom wall portion 16C1, and a holding member 30 (described below in detail) which forms part of the speaker 20 is mounted at the recessed bottom wall portion 16C1.

### (Speaker)

Next, explanation regarding the speaker 20 follows. The speaker 20 includes a speaker unit 22 that outputs acoustic signals (sound waves) by causing a diaphragm 24A to vibrate, and the case-shaped holding member 30 that holds the speaker unit 22. Note that the speaker 20 of the present exemplary embodiment is attached to the meter device 10 with an orientation so as to face the device rear side of the meter device 10 (in other words, a vehicle front side).

### (Speaker Unit)

The speaker unit 22 includes a speaker main body 24 having the diaphragm 24A, and a front cover 26 that is attached to a front side of the speaker main body 24. Note that in FIG. 1, the speaker main body 24 is illustrated as a block for the sake of convenience. Further, in FIG. 1, the central axis of the speaker unit 22 is denoted by reference numeral 22X.

The speaker main body 24 includes the diaphragm 24A that is arranged at the front side thereof, a magnetic circuit (not shown) having a magnetic gap, a cylindrical bobbin (not shown) that protrudes from a rear side of a central region of the diaphragm 24A, and a voice coil (not shown) that is wound around an outer peripheral side surface of the bobbin and is arranged in the magnetic gap of the magnetic circuit. A frame 24F that supports the diaphragm 24A and the magnetic circuit is provided at the rear side of the diaphragm 24A, at an outer peripheral side of the magnetic circuit. Note that in FIG. 1, for the sake of convenience, reference numeral 24A indicates a portion of the speaker main body 24 at which the diaphragm 24A is arranged, and reference numeral 24F indicates a portion of the speaker main body 24 at which the frame 24F is arranged. Further, a diaphragm, a magnetic circuit, a bobbin, a voice coil, and a frame are known, for example, from Japanese Patent Application Laid-Open (JP-A) No. 2012-100190, and detailed description thereof is omitted. Further, the axial direction of the speaker unit 22 (in other words, the axial direction of the central axis 22X) and the amplitude direction of the diaphragm 24A are the same.

The front cover 26 includes a cover main body portion 26A that is arranged so as to face the front side of the diaphragm 24A, and a fitting portion 26B that protrudes from the peripheral end portion of the cover main body portion 26A to the outer peripheral portion side of the frame 24F, and is fitted to the outer peripheral portion of the frame 24F. The cover main body portion 26A is formed in a circular plate shape with a plate thickness direction of the cover main body portion 26A being the axial direction of the speaker unit 22. Plural through holes 26H are formed in the cover main body portion 26A.

### (Holding Member)

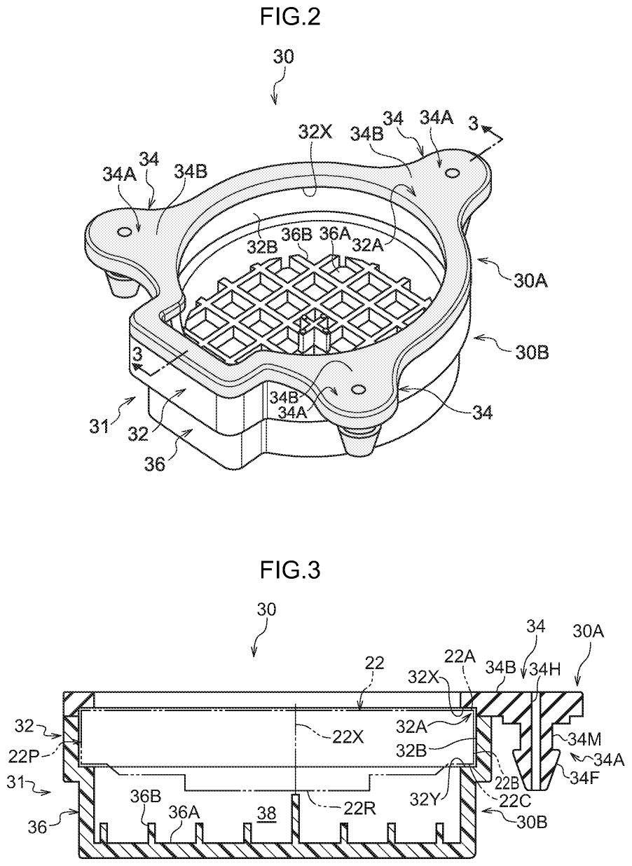

FIG. 2 illustrates a perspective view of the holding member 30, as viewed obliquely from the front side. Further, FIG. 3 illustrates an enlarged cross-sectional view of a state along the line 3-3 in FIG. 2. In FIG. 3, the outer shape of the speaker unit 22 is simplified and indicated by a two-dot chain line. In addition, in FIG. 3, the portion at which an outer peripheral portion 22P of the speaker unit 22 and the holding member 30 are in contact with each other is illustrated slightly apart for easy viewing of the drawing.

As illustrated in FIG. 3, the holding member 30 includes a holding portion 32 that holds an outer peripheral portion 22P side of the speaker unit 22. The holding portion 32 configures an open-side (the upper side in the drawing) portion of the holding member 30 and includes an open-side end portion 32A that is an open-side end portion of the holding member 30. The open-side end portion 32A of the holding portion 32 includes a front-side close-contact portion 32X that extends toward an inner side of the opening of the holding member 30 and closely contacts a front-side outer peripheral portion 22A of the speaker unit 22. Further, an inner surface 32B of the holding portion 32 is in close contact with an outer peripheral surface 22B of the speaker unit 22. Furthermore, the holding portion 32 includes a rear-side close-contact portion 32Y that is bent inward from the end portion of the inner surface 32B opposite to the front-side close-contact portion 32X and that is in close contact with a rear-side outer peripheral portion 22C of the speaker unit 22.

The holding member 30 also has an attachment overhang portion 34 that overhangs outward from the open-side end portion 32A of the holding portion 32. Plural (three in the present exemplary embodiment (see FIG. 2)) attachment overhang portions 34 are provided, and an affixed portion 34A that is to be fixed to an attachment target (here, the rear case 16 (see FIG. 1)) and a connecting portion 34B that connects the open-side end portion 32A of the portion 32 and the affixed portion 34A is provided. Note that the attachment overhang portion 34 may be understood as a holder portion.

The affixed portion 34A includes a portion protruding to a side opposite from the front side (the upper side in the drawing). A through hole 34H is formed through the affixed portion 34A in the protruding direction of the affixed portion 34A. Further, the affixed portion 34A is formed with a diameter-reduced portion 34M, which has a reduced outer diameter at an intermediate portion in the protruding direction, and a hook portion 34F, which includes a portion with an enlarged diameter from an end portion of the diameter-reduced portion 34M, is formed at a protruding direction leading end side of the affixed portion 34A. The hook portion 34F is elastically deformable from an outer peripheral side of the hook portion 34F toward a central axis of the through hole 34H. The outer diameter of the hook portion 34F gradually reduces toward the leading end side. As illustrated in FIG. 1, the hook portion 34F passes through the attachment hole 16H of the recessed bottom wall portion 16C1 and is engaged with a peripheral edge portion of the attachment hole 16H of the recessed bottom wall portion 16C1. Thereby, the holding member 30 is attached to the rear case 16.

Further, as illustrated in FIG. 3, the holding member 30 includes a rear-side cavity forming portion 36 that forms a cavity 38 at a rear surface 22R side of the speaker unit 22. The rear-side cavity forming portion 36 is formed continuously with the holding portion 32. As illustrated in FIG. 2, at an inner surface of a bottom wall portion 36A of the rear-side cavity forming portion 36, reinforcing ribs 36B are formed in a grid pattern. Note that a portion configured by the holding portion 32 and the rear-side cavity forming portion 36 may be referred to as an enclosure portion 31.

The holding member 30 is formed by two-color molding. In the holding member 30, an elastic portion 30A formed from a first material, which is an elastic material, is provided at an area from the open-side end portion 32A of the holding portion 32 to the attachment overhang portion 34. For the first material (elastic material) that forms the elastic portion 30A, as an example, a rubber material having a Shore A hardness of 40 degrees (for example, EPDM (ethylene propylene diene rubber), CR (chloroprene rubber), silicone rubber, and the like) can be applied. Note that the Shore A hardness of the first material may be, for example, greater than or equal to 25 degrees and less than 40 degrees, less than 25 degrees, or greater than 40 degrees and less than 45 degrees.

In the holding member 30, a rigid portion 30B is provided at the portion of the holding portion 32 excluding the open-side end portion 32A, and at the rear-side cavity forming portion 36. The rigid portion 30B, which includes the rear-side cavity forming portion 36, is formed from a second material that is harder than the first material. By the portion of the holding portion 32, excluding the open-side end portion 32A, and the rear-side cavity forming portion 36 being provided with the rigid portion 30B, the rigidity thereof is set to be higher than the portion from the open-side end portion 32A of the holding portion 32 to the attachment overhang portion 34 (the portion including the connecting portion 34B). For the second material that forms the rigid portion 30B, as an example, a rubber material having a Shore A hardness of 80 degrees (for example, EPDM (ethylene propylene diene rubber), CR (chloroprene rubber), silicone rubber, and the like), or a hard resin material (for example, an ABS resin (acrylonitrile/butadiene/styrene/copolymer), a PBT resin (polybutylene terephthalate), composites thereof, and the like) can be applied. Note that apart from 80 degrees, the Shore A hardness of the second material may be, for example, greater than or equal to 60 degrees and less than 80 degrees, or may be higher than 80 degrees.

### (Operation and Effect)

Next, explanation follows regarding the operation and effects of the above-described exemplary embodiment.

In the speaker 20 illustrated in FIG. 1, at the holding member 30, the elastic portion 30A formed from the first material, which is an elastic material, is provided at an area from the open-side end portion 32A of the holding portion 32 to the attachment overhang portion 34. Therefore, when vibration of the speaker unit 22 during audio output is transmitted to the rear case 16 via the holding member 30, the vibration is absorbed by the elastic portion 30A that is provided at an area from the open-side end portion 32A of the holding portion 32 to the attachment overhang portion 34. Since vibration is absorbed by a part of the holding member 30 in this manner, it is possible to suppress vibration transmitted to the rear case 16, which is an attachment target, while suppressing the number of parts. As a result, emission of unnecessary sound caused by vibration of the rear case 16 is suppressed. In addition, by reducing the number of parts, it is possible to suppress increases in costs.

Further, in the present exemplary embodiment, by the rigid portion 30B formed from the second material, which is harder than the first material, being provided at a portion of the enclosure portion 31 excluding the open-side end portion 32A, the rigidity of the portion of the enclosure 31 excluding the open-side end portion 32A is set to be higher than the portion from the open-side end portion 32A of the holding portion 32 to the attachment overhang portion 34. Thereby, the resonance of the enclosure part 31 is reduced. In addition, such a rigidity setting increases the stiffness of the air in the cavity 38 at the rear surface 22R side of the speaker unit 22, thereby suppressing absorption of vibration energy of the speaker unit 22 and suppressing sound pressure attenuation.

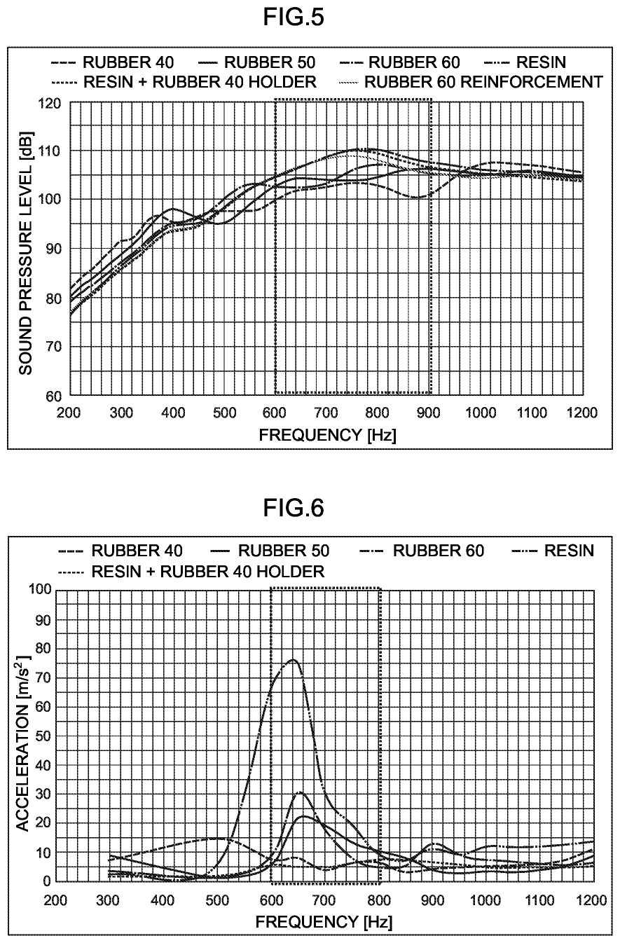

Here, supplementary explanation follows regarding the above-described operation and effects with reference to test results. Each of FIG. 5 and FIG. 6 is a graph comparing the characteristics of plural types of holding members, and illustrates the results of tests conducted with the holding member in a state of holding the speaker unit and attached to an attachment target.

In addition, in the legends of the graphs of FIG. 5 and FIG. 6, the numbers listed after the rubbers indicate the Shore A hardness. That is, in the graphs of FIG. 5 and FIG. 6, the dashed line indicates the test results of a holding member made of a rubber material with a Shore A hardness of 40 degrees, the thick solid line indicates the test results of a holding member made of a rubber material with a Shore A hardness of 50 degrees, and the dash-dot-dash line indicates the test results of a holding member made of a rubber material with a Shore A hardness of 60 degrees. EPDM was used as an example of the rubber material.

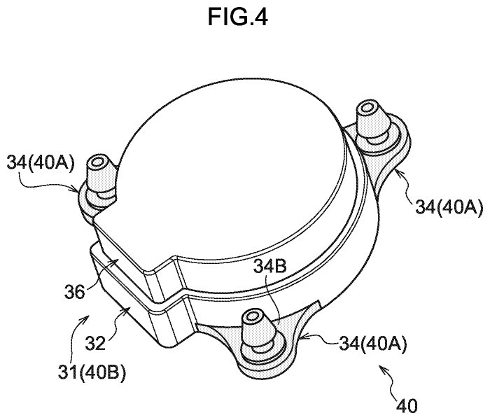

Further, in the graphs of FIG. 5 and FIG. 6, the two-dot chain line indicates the test results of a holding member made of a hard resin having a Shore A hardness higher than 80 degrees, and the dotted line (described as “Resin+Rubber 40 Holder” in the legend) indicates the test results for the holding member 40 illustrated in FIG. 4. The holding member 40 is an embodiment of a holding member applied to the speaker of the present disclosure. Note that in FIG. 4, for the sake of convenience, portions having substantially the same outer shape as the holding member 30 (see FIG. 2) are denoted by the same reference numerals. In the holding member 40 illustrated in FIG. 4, an elastic portion 40A formed from a rubber material with a Shore A hardness of 40 degrees (in other words, the first material that is an elastic material) is provided at the attachment overhang portions 34. The enclosure portion 31 of the holding member 40 is provided with a rigid portion 40B formed from a hard resin material with a Shore A hardness higher than 80 degrees (the second material that is harder than the first material). By being provided with the rigid portion 40B, the enclosure portion 31 is set to have a rigidity that is higher than that of the attachment overhang portion 34 (the portion including the connecting portion 34B). In addition, in the graph of FIG. 5, the thin solid line (which is described as “rubber 60 reinforcement” in the legend) indicates the test results of a holding member that is formed entirely from a rubber material with a Shore A hardness of 60 degrees and is reinforced by attaching a hard resin piece with a Shore A hardness higher than 80 degrees to a rear surface and an outer peripheral surface of the enclosure portion. As an example of the hard resin material, a composite material containing ABS was used.

FIG. 5 illustrates a graph comparing sound pressures measured at predetermined positions at the front side of the speaker. In FIG. 5, the horizontal axis indicates frequency (Hz) and the vertical axis indicates sound pressure level (dB). Further, in FIG. 5, the range of 600 Hz to 900 Hz surrounded by the dotted line indicates the important range.

Looking at the important range of the graph illustrated in FIG. 5, in a case in which the holding member is formed from a soft rubber material (a rubber material with a Shore A hardness of 40 degrees) (see the dashed line), sound pressure decreased, and in a case in which the holding member is formed from a hard resin material (see the two-dot chain line), it can be seen that the sound pressure is ensured well. Further, in the case of a holding member that is formed entirely from a rubber material with a Shore A hardness of 60 degrees and the enclosure portion of the holding member is reinforced (see the thin solid line), it can be seen that the sound pressure improved compared to a case of the holding member that is formed from a rubber material with a Shore A hardness of 60 degrees and that is not reinforced (see the one-dot chain line). Furthermore, in the case in which the holding member 40 (see FIG. 4) was used (see the dotted line), it can be seen that characteristics similar to those in the case in which the holding member is formed from a hard resin material (see the two-dot chain line) are obtained.

From the above test results, it can be seen that a hard enclosure portion is more advantageous in order to ensure sound pressure. Further, it can be seen that even if the attachment overhang portion 34 (holder portion) is soft, the effect on the sound pressure is small.

FIG. 6 illustrates a graph comparing the vibration accelerations of an attachment target. In FIG. 6, the horizontal axis indicates frequency (Hz), and the vertical axis indicates acceleration (m/s²). Acceleration was measured by an acceleration sensor installed above a predetermined position of the attachment target to which the holding member was attached. Therefore, if the value of acceleration is large, it can be said that a large vibration was transmitted from the holding member to the attachment target. Further, in FIG. 6, the range of 600 Hz to 800 Hz surrounded by the dotted line indicates the important range.

Looking at the important range of the graph illustrated in FIG. 6, in a case in which the holding member is formed from a hard resin material (see the two-dot chain line), vibration was transmitted with almost no suppression thereof, and in a case in which the holding member is formed from a soft rubber material (a rubber material having a Shore A hardness of 40 degrees) (see the dashed line), it can be seen that vibration is greatly reduced. Further, looking at the important range of FIG. 6, it can be seen that in a case in which the holding member 40 (see FIG. 4) was used (see the dotted line), the vibration reduction is generally maintained.

From the above test results, it can be seen that it is advantageous for the attachment overhang portion 34 (the holder portion) to be soft in order to suppress the transmission of vibration to the attachment target. Further, it can be seen that even if the enclosure portion 31 is hard, this has little effect on the suppression of vibration transmission.

As described above, according to the speaker 20 illustrated in FIG. 1 to FIG. 3 of the first exemplary embodiment, it is possible to achieve both ensuring of sound pressure and reduction of vibration transmitted to the attachment, while suppressing the number of parts.

Further, as illustrated in FIG. 1, in the first exemplary embodiment, since the front-side close-contact portion 32X of the elastic open-side end portion 32A of the holding portion 32 is in close contact with the front-side outer peripheral portion 22A of the speaker unit 22, sound leakage from the outer peripheral side of the speaker unit 22 is effectively reduced by the front-side close-contact portion 32X.

### Second Exemplary Embodiment

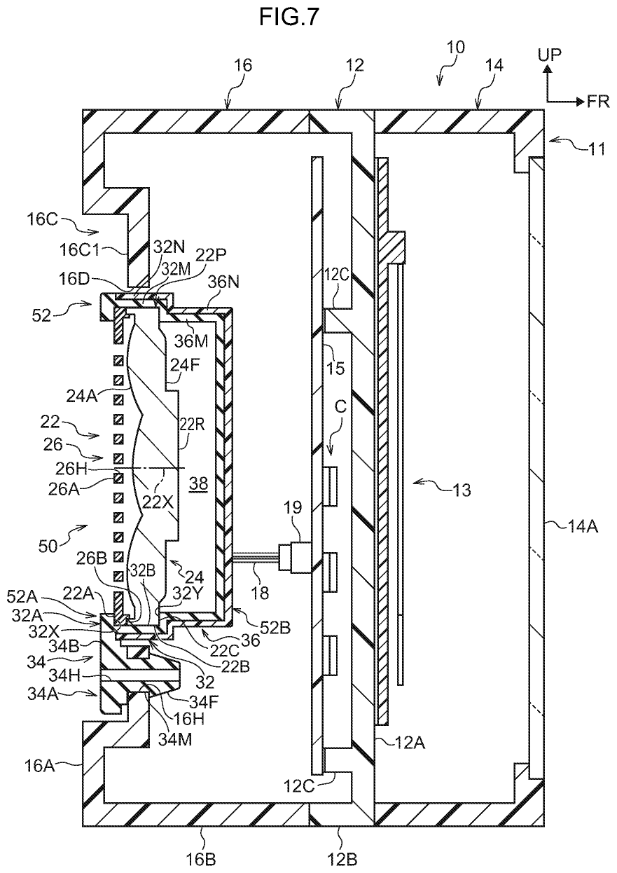

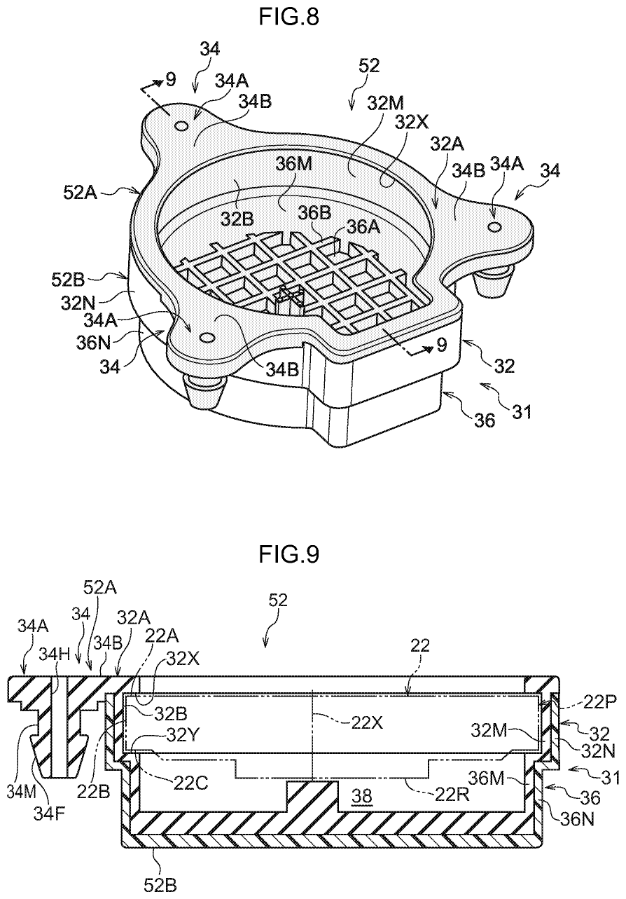

Next, explanation follows regarding a speaker 50 according to a second exemplary embodiment of the present disclosure, with reference to FIG. 7 to FIG. 9. FIG. 7 illustrates a cross-sectional view illustrating a simplified overall configuration in which a speaker 50 according to a second exemplary embodiment is installed at the meter device 10. FIG. 8 illustrates a perspective view of the holding member 52 in FIG. 7, as viewed obliquely from the front side, and FIG. 9 illustrates an enlarged cross-sectional view of a state along the line 9-9 in FIG. 8.

As illustrated in FIG. 7 to FIG. 9, the speaker 50 differs from the speaker 20 according to the first exemplary embodiment (see FIG. 1 to FIG. 3) in that it includes the holding member 52 in place of the holding member 30 (see FIG. 1 to FIG. 3). Other configurations are substantially the same as the configurations of the first exemplary embodiment. Therefore, components having substantially the same configuration as components in the first exemplary embodiment are denoted by the same reference numerals, and explanations thereof are omitted. Note that although the meter device 10 illustrated in FIG. 7 has a configuration in which the speaker 50 is installed in place of the speaker 20 of the first exemplary embodiment (see FIG. 1), the same reference numeral as in the first exemplary embodiment is denoted for the sake of convenience.

Further, the outer shape of the holding member 52 is substantially the same as the outer shape of the holding member 30 of the first exemplary embodiment (see FIG. 1 to FIG. 3). Therefore, for the sake of convenience, outer parts of the holding member 52 that are substantially the same as those of the holding member 30 of the first exemplary embodiment (see FIG. 1 to FIG. 3) are denoted by the same reference numerals, and description thereof is omitted.

As illustrated in FIG. 8 and FIG. 9, the holding member 52 is formed by two-color molding. The holding member 52 is provided with an elastic portion 52A formed from a first material, which is an elastic material, and a rigid portion 52B formed from a second material that is harder than the first material. The first material is the same material as the first material described in the first exemplary embodiment, and the second material is the same material as the second material described in the first exemplary embodiment.

The elastic portion 52A is provided in a continuous manner at a portion consisting of a portion 36M that configures the inner surface side of the rear-side cavity forming portion 36, a portion 32M that configures the inner surface side of the holding portion 32, the open-side end portion 32A, and the attachment overhang portion 34. The rigid portion 52B is provided in a continuous manner at a portion consisting of a portion 36N that configures the outer surface side of the rear-side cavity forming portion 36 and a portion 32N that configures the outer surface side of the holding portion 32 and the portion of the holding portion 32 excluding the open-side end portion 32A. By the rear-side cavity forming portion and the portion of the holding portion 32 excluding the open-side end portion 32A being provided with the rigid portion 52B, the rigidity thereof is set to be higher than the portion from the open-side end portion 32A of the holding portion 32 to the attachment overhang portion 34 (the portion including the connecting portion 34B).

The same operation and effects as those of the above-described first exemplary embodiment can also be obtained by the configuration of the above-described second exemplary embodiment. Further, as illustrated in FIG. 7, the inner surface 32B of the holding portion 32 is in close contact with the outer peripheral surface 22B of the speaker unit 22, the portion 32M that forms the inner surface side of the holding portion 32 is part of the elastic portion 52A, and the portion 32N that is arranged at the outer surface side with respect to the portion 32M configuring the inner surface side of the holding portion 32 and that configures the outer surface side is part of the rigid portion 52B. Therefore, since elastic deformation of the portion 32M, which configures the inner surface side, toward the outer side is suppressed by the portion 32N that configures the outer surface side, contact between the inner surface 32B of the holding portion 32 and the outer peripheral surface 22B of the speaker unit 22 is improved, and sound leakage from the outer peripheral side of the speaker unit 22 is suppressed.

### Third Exemplary Embodiment

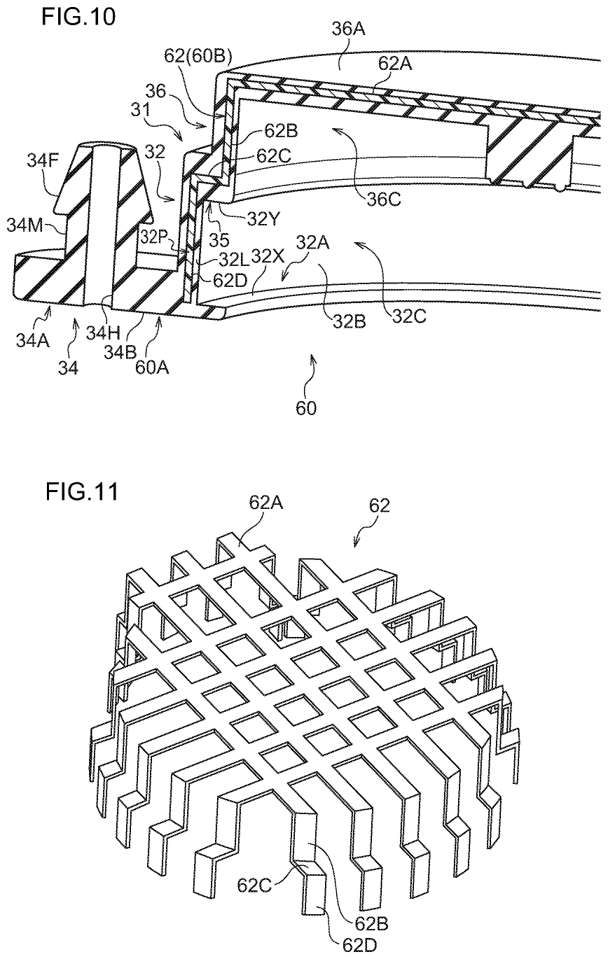

Next, explanation follows regarding a speaker according to a third exemplary embodiment of the present disclosure, with reference to FIG. 10 and FIG. 11. FIG. 10 illustrates a perspective view of a cross-section of a half part of a holding member 60 applied to a speaker according to a third exemplary embodiment. Further, FIG. 11 illustrates a perspective view of a skeleton portion 62 provided at the holding member 60. Note that since the speaker unit that is held by the holding member 60 in the speaker of the third exemplary embodiment is the same as the speaker unit 22 of the first exemplary embodiment (see FIG. 1), and the structure for holding the speaker unit is also the same as the structure for holding the speaker unit 22 described in the first exemplary embodiment (see FIG. 1), illustration and description of the speaker unit are omitted. Further, the speaker of the third exemplary embodiment is installed, as an example, at a meter device that is the same as that of the first exemplary embodiment (see the meter device 10 illustrated in FIG. 1).

Further, the outer shape of the holding member 60 is substantially the same as the outer shape of the holding member 30 of the first exemplary embodiment (see FIG. 1 to FIG. 3). Therefore, for the sake of convenience, outer parts of the holding member 60 that are substantially the same as those of the holding member 30 of the first exemplary embodiment (see FIG. 1 to FIG. 3) are denoted by the same reference numerals, and description thereof is omitted.

As illustrated in FIG. 10, the holding member 60 is formed by two-color molding. The holding member 60 is provided with an elastic portion 60A formed from a first material, which is an elastic material, and a rigid portion 60B formed from a second material that is harder than the first material. The first material is the same material as the first material described in the first exemplary embodiment, and the second material is the same material as the second material described in the first exemplary embodiment.

The skeleton portion 62 that configures the rigid portion 60B is embedded in a portion of the enclosure portion 31 of the holding member 60 excluding the terminal side of the open-side end portion 32A. In addition, the elastic portion 60A is provided in a continuous manner at a portion consisting of the attachment overhang portion 34 and the portion of the enclosure portion 31 excluding the skeleton portion 62.

As illustrated in FIG. 11, the skeleton portion 62 is formed in a grid pattern. As illustrated in FIG. 10 and FIG. 11, the skeleton portion 62 includes a bottom reinforcing portion 62A, a first peripheral wall reinforcing portion 62B, a step reinforcing portion 62C, and a second peripheral wall reinforcing portion 62D. As illustrated in FIG. 10, the bottom reinforcing portion 62A is embedded in the bottom wall portion 36A of the rear-side cavity forming portion 36. The first peripheral wall reinforcing portion 62B is formed continuously with the bottom reinforcing portion 62A and is embedded in a peripheral wall portion 36C of the rear-side cavity forming portion 36. The step reinforcing portion 62C is formed continuously with the first peripheral wall reinforcing portion 62B and is embedded in a boundary step portion 35 between the peripheral wall portion 36C of the rear-side cavity forming portion 36 and the peripheral wall portion 32C of the holding portion 32. The second peripheral wall reinforcing portion 62D is formed continuously with the step reinforcing portion 62C and is embedded in the peripheral wall portion 32C of the holding portion 32. With such a configuration, the majority of the enclosure portion 31 including the rear-side cavity forming portion 36 is set to have a higher rigidity than the attachment overhang portion 34 including the connecting portion 34B.

The same operation and effects as those of the above-described first exemplary embodiment can also be obtained by the configuration of the above-described third exemplary embodiment. In addition, in the holding portion 32, a portion 32L that configures the inner surface side is part of the elastic portion 60A, and part of the rigid portion 60B is provided with a space in a circumferential direction at a portion 32P at the outer surface side with respect to the portion 32L that configures the inner surface side. Therefore, in substantially the same manner as in the second exemplary embodiment, the contact between the inner surface 32B of the holding portion 32 and the outer peripheral portion of the speaker unit (not shown) is improved.

### Fourth Exemplary Embodiment

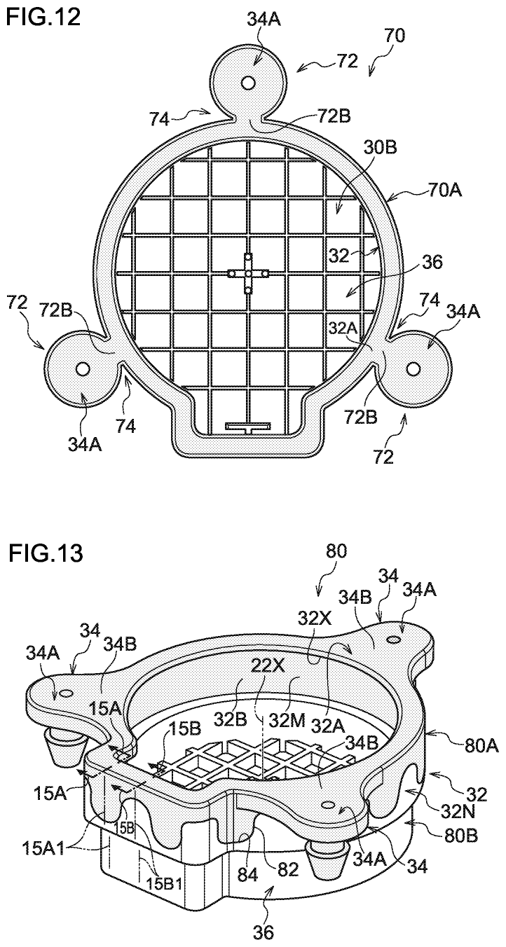

Next, explanation follows regarding a speaker according to a fourth exemplary embodiment of the present disclosure, with reference to FIG. 12. FIG. 12 illustrates a front view of a holding member 70 applied to a speaker according to a fourth exemplary embodiment. Note that since the speaker unit that is held by the holding member 70 in the speaker of the fourth exemplary embodiment is the same as the speaker unit 22 of the first exemplary embodiment (see FIG. 1), and the structure for holding the speaker unit is also the same as the structure for holding the speaker unit 22 described in the first exemplary embodiment (see FIG. 1), illustration and description of the speaker unit are omitted. Further, the speaker of the fourth exemplary embodiment is installed, as an example, at a meter device similar to that is the same as that of the first exemplary embodiment (see the meter device 10 illustrated in FIG. 1).

As illustrated in FIG. 12, the holding member 70 differs from the holding member 30 of the first exemplary embodiment (see FIG. 2) in that it includes an attachment overhang portion 72 in place of the attachment overhang portion 34 (see FIG. 2). Other configurations are the same as the configurations of the first exemplary embodiment. In the fourth exemplary embodiment, components having the same configuration as components in the first exemplary embodiment are denoted by the same reference numerals, and explanations thereof are omitted.

The attachment overhang portion 72 includes an affixed portion 34A that is to be fixed to an attachment target (the same component as the affixed portion 34A of the first exemplary embodiment (see FIG. 2)), and a connecting portion 72B that connects the open-side end portion 32A of the holding portion 32 and the affixed portion 34A. The connecting portion 72B is formed with a constricted portion 74 as a rigidity reducing portion that reduces the rigidity of the connecting portion 72B with respect to the axial direction of the speaker unit (not shown) (that is, the direction perpendicular to the paper plane of FIG. 12).

The holding member 70 is formed by two-color molding in the same manner as the holding member 30 of the first exemplary embodiment (see FIG. 2). The holding member 70 is provided with an elastic portion 70A formed from a first material, which is an elastic material, and a rigid portion 30B formed from a second material that is harder than the first material (the same component as the rigid portion 30B of the first exemplary embodiment 30B (FIG. 2)). The first material is the same material as the first material described in the first exemplary embodiment. The elastic portion 70A is provided at an area from the open-side end portion 32A of the holding portion 32 to the attachment overhang portion 72.

The same operation and effects as those of the above-described first exemplary embodiment can also be obtained by the configuration of the above-described fourth exemplary embodiment. In addition, in the fourth exemplary embodiment, when vibration of the speaker unit (not shown, see the speaker unit 22 in FIG. 1) during audio output is transmitted via the holding member 70 to the attachment target of the holding member 70 (not shown, see the rear case in FIG. 1), the connecting portion 72B is elastically deformed, thereby absorbing the vibration.

### Fifth Exemplary Embodiment

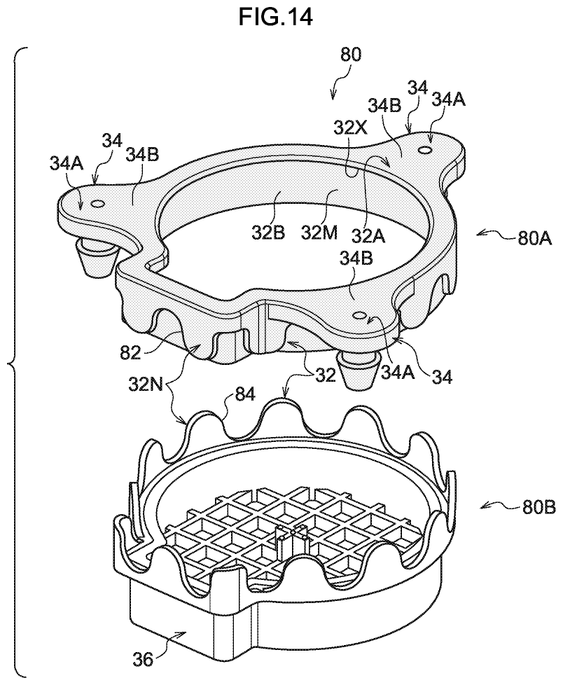

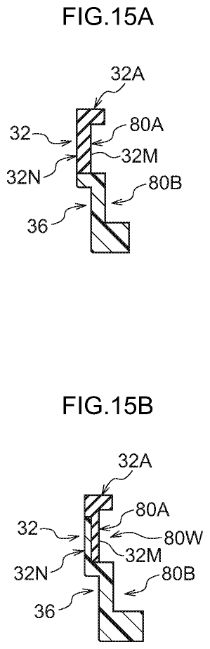

Next, explanation follows regarding a speaker according to a fifth exemplary embodiment of the present disclosure, with reference to FIG. 13 to FIG. 15. FIG. 13 illustrates a perspective view of a holding member 80 applied to a speaker according to the fifth embodiment, and FIG. 14 illustrates an exploded perspective view of an elastic portion 80A and a rigid portion 80B of the holding member 80. Further, FIG. 15A illustrates an enlarged cross-sectional view of a state along the line 15A-15A and passing through the two-dot chain line 15A1 in FIG. 13, and FIG. 15B is an enlarged cross-sectional view illustrating a state along the line 15B-15B and passing through the two-dot chain line 15B1 in FIG. 13. Note that since the speaker unit that is held by the holding member 80 in the speaker of the fifth exemplary embodiment is the same as the speaker unit 22 of the first exemplary embodiment (see FIG. 1), and the structure for holding the speaker unit is also the same as the structure for holding the speaker unit 22 described in the first exemplary embodiment (see FIG. 1), illustration and description of the speaker unit are omitted. Further, the speaker of the fifth exemplary embodiment is installed, as an example, at a meter device that is the same as that of the first exemplary embodiment (see the meter device 10 illustrated in FIG. 1).

Further, the outer shape of the holding member 80 is substantially the same as the outer shape of the holding member 30 of the first exemplary embodiment (see FIG. 1 to FIG. 3). Therefore, for the sake of convenience, outer parts of the holding member 80 that are substantially the same as those of the holding member 30 of the first exemplary embodiment (see FIG. 1 to FIG. 3) are denoted by the same reference numerals, and description thereof is omitted.

As illustrated in FIG. 13 to FIG. 15B, the holding member 80 is formed by two-color molding. The holding member 80 is provided with an elastic portion 80A formed from a first material, which is an elastic material, and a rigid portion 80B formed from a second material that is harder than the first material. The first material is the same material as the first material described in the first exemplary embodiment, and the second material is the same material as the second material described in the first exemplary embodiment.

The elastic portion 80A is provided at a portion configured integrally with the attachment overhang portion 34 and part of the holding portion 32 (more specifically, part of the open-side end portion 32A, the portion 32M forming the inner surface side, and the portion 32N forming the outer surface side). The rigid portion 80B is provided at a portion configured integrally with another part of the holding portion 32 and the rear-side cavity forming portion 36, and is formed integrally with the elastic portion 80A.

At the elastic portion 80A, a concave-convex fitting portion 82 that has concave shapes and convex shapes (more specifically a wavelike shape) in the axial direction of the speaker unit (not shown) (see the axial direction of the central axis 22X indicated by the two-dot chain line in FIG. 13) is provided at a boundary portion with the rigid portion 80B at the portion 32N that configures the outer surface side of the holding portion 32. In order to correspond to this, at the rigid portion 80B, a concave-convex fitting portion 84 that has concave shapes and convex shapes (more specifically a wavelike shape) in the axial direction of the speaker unit (not shown) (see the axial direction of the central axis 22X indicated by the two-dot chain line in FIG. 13) is provided at a boundary portion with the elastic portion 80A at the portion 32N that configures the outer surface side of the holding portion 32. The concave-convex fitting portions 82 and 84 are formed so as to fit together.

Therefore, as illustrated in FIG. 15B, an overlapping portion 80W, at which the elastic portion 80A and the rigid portion 80B overlap in a plate thickness direction, is provided at the holding portion 32. The overlapping portion 80W has lower rigidity than the rear-side cavity forming portion 36, and higher rigidity than the portion configured by a single layer of the elastic portion 80A, such as the holding portion 32 illustrated in FIG. 15A. Further, the length of the overlapping portion 80W illustrated in FIG. 15B, in the vertical direction of the drawing, varies along the circumferential direction of the holding portion 32 illustrated in FIG. 13. As a result, density is dispersed in the holding member 80 in the area from the open-side end portion 32A of the holding portion 32 to the rear-side cavity forming portion 36.

The same operation and effects as those of the above-described first exemplary embodiment can also be obtained by the configuration of the above-described fifth exemplary embodiment. In addition, in the fifth exemplary embodiment, as illustrated in FIG. 13 and FIG. 15B, at the holding portion 32, the portion 32M that configures the inner surface side is part of the elastic portion 80A, and the portion that configures the rigid portion 80B is included at the portion 32N that configures the outer surface side disposed at the outer side with respect to the portion 32M that configures the inner surface side of the holding portion 32; therefore, in substantially the same manner as in the second and third exemplary embodiments, contact between the inner surface 32B of the holding portion 32 and the outer peripheral portion of the speaker unit (not shown) is improved.

Further, in the fifth exemplary embodiment, the elastic portion 80A and the rigid portion 80B are provided with the concave-convex fitting portions 82 and 84 that fit to each other at their boundary portions. Therefore, it is possible to improve the strength of bonding between the elastic portion 80A and the rigid portion 80B. In addition, by providing the concave-convex fitting portions 82 and 84 at the portion 32N that configures the outer surface side of the holding portion 32, it is possible to provide a distance from the elastic portion 80A to the rigid portion 80B to be varied in the area from the open-side end portion 32A of the holding portion 32 to the rear-side cavity forming portion 36, at the holding member 80, and density is dispersed. As a result, the internal loss of the holding member 80 increases in this area, and peaks and dips in frequency characteristics can be reduced, thereby improving sound quality.

### Sixth Exemplary Embodiment

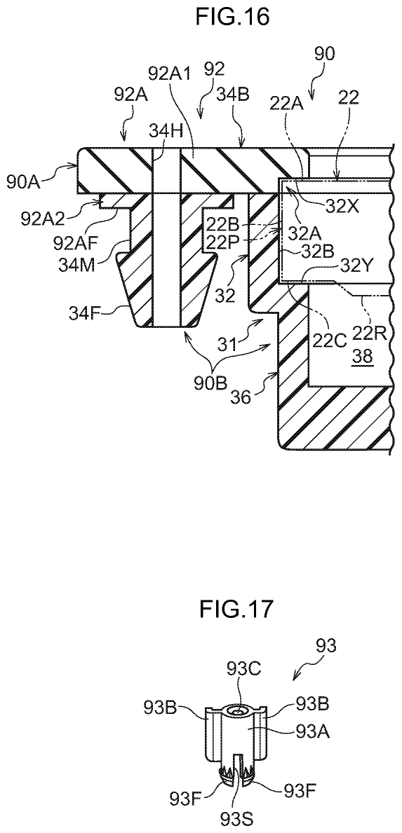

Next, explanation follows regarding a speaker according to a sixth exemplary embodiment of the present disclosure, with reference to FIG. 16. FIG. 16 illustrates a cross-sectional view of a holding member 90 applied to a speaker according to a sixth exemplary embodiment. The speaker of the sixth exemplary embodiment has the same configuration as the speaker 20 of the first exemplary embodiment (see FIG. 1 to FIG. 3) except for the points described below and is installed, as an example, at a meter device that is the same as that of the first exemplary embodiment (see the meter device 10 illustrated in FIG. 1).

As illustrated in FIG. 16, the holding member 90 differs from the holding member 30 of the first exemplary embodiment (see FIG. 2) in that it includes an attachment overhang portion 92 in place of the attachment overhang portion 34 (see FIG. 2). Other configurations of the sixth exemplary embodiment are the same as the configurations of the first exemplary embodiment. In the sixth exemplary embodiment, components having the same configuration as components in the first exemplary embodiment are denoted by the same reference numerals, and explanations thereof are omitted. Note that, as an example, the holding member 90 is formed by two-color molding.

The attachment overhang portion 92 differs from the attachment overhang portion 34 of the first exemplary embodiment (see FIG. 2) in that the affixed portion 92A is configured by two materials. Note that the connecting portion 34B of the attachment overhang portion 92 has the same configuration as the connecting portion 34B of the first exemplary embodiment. Further, the outer shape of the affixed portion 92A is substantially the same as the outer shape of the affixed portion 34A of the first exemplary embodiment (see FIG. 3). Therefore, for the sake of convenience, outer parts of the affixed portion 92A that are substantially the same as those of the affixed portion 34A of the first exemplary embodiment (see FIG. 3) are denoted by the same reference numerals, and description thereof is omitted.

The affixed portion 92A includes a first component portion 92A1 that configures a portion that extends from the connecting portion 34B to the side opposite from the open-side end portion 32A of the holding portion 32, and a second component portion 92A2 that is continuous with the first component portion 92A1 and protrudes to the side opposite from the front side (the upper side in the drawing). The second component portion 92A2 includes a brim-shaped flange portion 92AF at the joint with the first component portion 92A1.

The first component portion 92A1 is formed from the same first material as the connecting portion 34B and the like. On the other hand, the second component portion 92A2 is formed from a material that is harder than the first material, and here, as an example, the same second material as the rear-side cavity forming portion 36 or the like. That is, in the sixth exemplary embodiment, at the holding member 90, the elastic portion 90A is provided at the area consisting of the open-side end portion 32A of the holding portion 32, the connecting portion 34B of the attachment overhang portion 92, and the first component portion 92A1 of the affixed portion 92A. Further, at the holding member 90, the rigid portion 90B is provided at the portion of the holding portion 32 excluding the open-side end portion 32A, at the rear-side cavity forming portion 36, and at the second component portion 92A2 of the affixed portion 92A.

The same operation and effects as those of the above-described first exemplary embodiment can also be obtained by the configuration of the above-described sixth exemplary embodiment. Further, in the sixth exemplary embodiment, since the second component portion 92A2 of the affixed portion 92A is formed from a material that is harder than the first material, the attachment strength and the attachment accuracy of the affixed portion 92A with respect to an attachment target (here, the rear case 16 (see FIG. 1)) are improved. In addition, since the second component portion 92A2 includes the brim-shaped flange portion 92AF at the joint with the first component portion 92A1, it is possible to stably transmit force from the first component portion 92A1 to the second component portion 92A2 when attaching to an attachment target.

### Modified Examples of Sixth Exemplary Embodiment

A second component portion 93 illustrated in FIG. 17 may be joined to the first component portion 92A1 (see FIG. 16) in place of the second component portion 92A2 illustrated in FIG. 16. The second component portion 93 is formed from a material that is harder than the first material, and here, as an example, the same second material as the second component portion 92A2 or the like.

The second component portion 93 includes a cylindrical tubular portion 93A, ribs 93B that are each continuously provided at the side surface of the tubular portion 93A, and a wedge portion 93C that is provided in the tubular portion 93A, and the end portion at the upper side in the drawing serves as the joint with the first component portion 92A1 (see FIG. 16). A surface (not shown) that is orthogonal to the central axis direction of the tubular portion 93A is provided at the leading end side (lower side in the drawings) of each rib 93B, and this surface is used to hold down an attachment target. Further, plural slits 93S parallel to the central axis direction of the tubular portion 93A are formed at the leading end side of the cylindrical portion 93A, and a hook portion 93F having a protrusion that protrudes outward in the radial direction of the cylindrical portion 93A is formed. The hook portion 93F is elastically deformable from an outer peripheral side of the hook portion 93F toward the central axis of the tubular portion 93A. Furthermore, the wedge portion 93C can be pushed in, and by the wedge portion 93C being pushed in when it is attached to an attachment target (here, the rear case 16 (see FIG. 1)), the hook portion 93F, which is engaged with the attachment target, elastically deforming from the outer peripheral side thereof toward the central axis of the tubular portion 93A can be prevented. Therefore, it is possible to effectively prevent the second component portion 93 from coming off the attachment target.

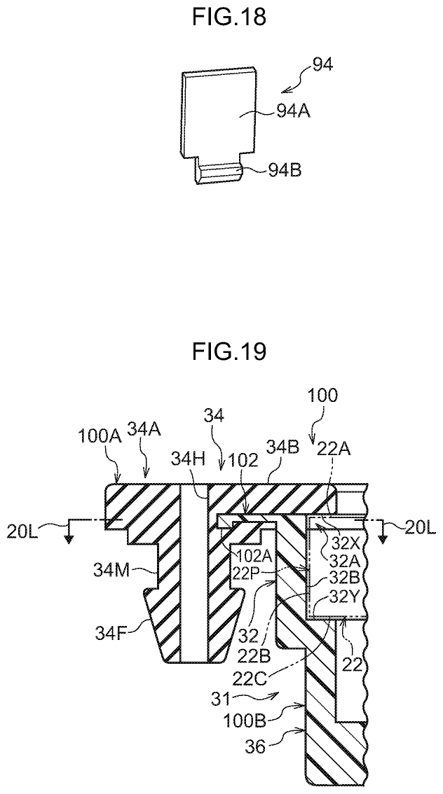

Further, as another modified example, the through hole 34H is not formed at the affixed portion 92A illustrated in FIG. 16, and a second component portion 94 illustrated in FIG. 18 may be joined to the first component portion 92A1 (see FIG. 16) in place of the second component portion 92A2 illustrated in FIG. 16. The second component portion 94 is formed from a material that is harder than the first material, and here, as an example, the same second material as the second component portion 92A2 or the like.

The second component portion 94 is a snap-fit portion which includes a flat plate-like extension portion 94A and an engaging portion 94B that is provided at the leading end portion of the extension portion 94A, and an end portion thereof at the upper side in the drawing is a joint with the first component 92A1 (see FIG. 16). An attachment hole (not shown) into which the second component portion 94 is inserted is formed through the attachment target. In the modified example to which the second component portion 94 is applied, attachment and detachment can be performed relatively easily.

### Seventh Exemplary Embodiment

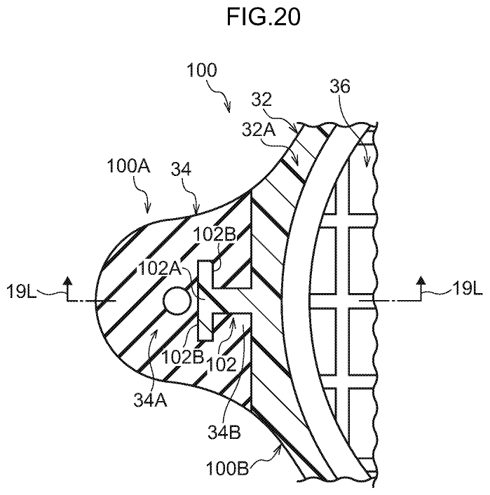

Next, explanation follows regarding a speaker according to a seventh exemplary embodiment of the present disclosure, with reference to FIG. 19 and FIG. 20. FIG. 19 illustrates a cross-sectional view of a part of a holding member 100 applied to a speaker according to a seventh exemplary embodiment (a cross-sectional view of a state along the line 19L-19L in FIG. 20). FIG. 20 illustrates a cross-sectional view of a state along the line 20L-20L in FIG. 19. The speaker of the seventh exemplary embodiment has the same configuration as the speaker 20 of the first exemplary embodiment (see FIG. 1 to FIG. 3) except for the points described below and is installed, as an example, at a meter device that is the same as that of the first exemplary embodiment (see the meter device 10 illustrated in FIG. 1).

As illustrated in FIG. 19 and FIG. 20, the outer shape of the holding member 100 is substantially the same as the outer shape of the holding member 30 of the first exemplary embodiment (see FIG. 1 to FIG. 3). Therefore, for the sake of convenience, outer parts of the holding member 100 that are substantially the same as those of the holding member 30 of the first exemplary embodiment (see FIG. 1 to FIG. 3) are denoted by the same reference numerals, and description thereof is omitted.

The holding member 100 is formed by two-color molding. The holding member 100 is provided with an elastic portion 100A formed from a first material, which is an elastic material, and a rigid portion 100B formed from a second material that is harder than the first material. The first material is the same material as the first material described in the first exemplary embodiment, and the second material is the same material as the second material described in the first exemplary embodiment. In the seventh exemplary embodiment, the arrangement configuration of the elastic portion 100A and the rigid portion 100B at the portion from the holding portion 32 to the attachment overhang portion 34 differs from the arrangement configuration of the elastic portion 30A and the rigid portion 30B in the first exemplary embodiment (both shown in FIG. 3). Other configurations of the seventh exemplary embodiment are the same as the configurations of the first exemplary embodiment. In the seventh exemplary embodiment, components having the same configuration as components in the first exemplary embodiment are denoted by the same reference numerals, and explanations thereof are omitted.

As illustrated in FIG. 19, the elastic portion 100A is provided at an area that includes the majority of the attachment overhang portion 34 and majority of the open-side end portion 32A of the holding portion 32 (the portion of the holding member 100 other than a rigid portion 100B, which is described below). The rigid portion 100B is provided at an area including the rear-side cavity forming portion 36 and part of the holding portion 32. Further, as part of the rigid portion 100B, an extension portion 102, which extends from the portion of the holding portion 32 which configures the rigid portion 100B and which is embedded inside the portion that configures the elastic portion 100A of the attachment overhang portion 34, is provided. The extension portion 102 is adjacent to the portion that configures the elastic portion 100A at the attachment overhang portion 34.

The area in which the rigid portion 100B is provided at the holding portion 32 is slighter larger at the open-side end portion 32A side (the upper side in the drawing) than the area in which the rigid portion 30B is provided at the holding portion 32 of the first exemplary embodiment (see FIG. 3), and includes part of the open-side end portion 32A. An extension direction leading end portion 102A of the extension portion 102 is thicker than the plate thickness of other portions and protrudes in the same direction as the protruding direction (the downward direction in the drawing) of the affixed portion 34A. As illustrated in FIG. 20, the extension portion 102 includes retaining portions 102B extending on both sides from the extension direction leading end portion 102A, and has a T shape when viewed from the front (when viewed in the direction of FIG. 20).

Substantially the same operation and effects as those of the above-described first exemplary embodiment can also be obtained by the configuration of the above-described seventh exemplary embodiment. In addition, in the seventh embodiment, by the extension portion 102 being provided as part of the rigid portion 100B, it is possible to improve the strength of bonding between the rigid portion 100B and the elastic portion 100A at the portion from the holding portion 32 to the attachment overhang portion 34. That is, in the seventh exemplary embodiment, it is possible to effectively prevent the elastic portion 100A from being separated from the rigid portion 100B.

### Supplementary Explanation of Exemplary Embodiments

Although the speaker unit 22 illustrated in FIG. 1 described in the first exemplary embodiment includes the front cover 26, the speaker unit may be configured without a front cover.

Further, in the above-described third exemplary embodiment, as illustrated in FIG. 10, the skeleton portion 62 that configures the rigid portion 60B is embedded in the portion of the enclosure portion 31 of the holding member 60 excluding the terminal side of the open-side end portion 32A; however, as a modified example, a skeleton portion (62) could be embedded only in a rear-side cavity forming portion (36).

In addition, in the above-described fourth exemplary embodiment, as illustrated in FIG. 12, the constricted portion 74 is formed at the connecting portion 72B as a rigidity reducing portion; however, the rigidity reducing portion that is formed at the connecting portion may be, for example, a rigidity reducing portion having a shape other than a constricted shape, such as a thin-walled shape with a reduced thickness, or forming a through-hole to reduce the rigidity.

Further, in the above-described sixth exemplary embodiment, as illustrated in FIG. 16, the affixed portion 92A includes the first component portion 92A1 that is configured by the first material and the second component portion 92A2 that is configured by the second material; however, the affixed portion may be formed only from a material that is harder than the first material.

Furthermore, in the above-described sixth exemplary embodiment and the modified examples thereof, the second component portions 92A2, 93, and 94 illustrated in FIG. 16 to FIG. 18 are formed by the same second material as the rear-side cavity forming portion 36 and the like; however, as a modified example, the second component portions (92A2, 93, and 94) may be formed from a material that is not the same second material as the rear-side cavity forming portion (36) and the like, but is harder than the first material.

Further, in the first to seventh exemplary embodiments, although examples were described in which the second material is a resin material, the second material may be a metal material. Further, in a case in which a resin material is applied as the second material, the resin material may contain reinforcing fibers.

In addition, in the first to seventh exemplary embodiments, the holding members 30, 52, 60, 70, 80, 90, and 100 are formed by two-color molding; however, the holding member may be molded by a molding method other than two-color molding, such as insert molding or outsert molding, or the elastic portion and the rigid portion may be formed separately and then made integral.

Note that the above-described first to seventh exemplary embodiments and the plural modified examples may be combined as appropriate.

Although explanation has been given regarding examples of the present disclosure, the present disclosure is not limited to the above descriptions, and, in addition to the above, obviously various other modifications may be implemented within a range that does not depart from the scope of the present disclosure.

1. A speaker, comprising:
a speaker unit; and
a holding member holding the speaker unit and configured to be attached to an attachment target,
wherein the holding member comprises:
a holding portion configuring an open-side portion of the holding member, the holding portion including an open-side end portion and holding an outer peripheral portion of the speaker unit;
an attachment overhang portion overhanging outwardly from the open-side end portion of the holding portion, and including an affixed portion that is configured to be fixed to the attachment target and to a connecting portion that connects the open-side end portion of the holding portion and the affixed portion; and
a rear-side cavity forming portion formed continuously with the holding portion, the rear-side cavity forming portion forming a cavity at a rear surface side of the speaker unit,
wherein an elastic portion formed from a first material, which is an elastic material, is provided at least at the connecting portion of the attachment overhang portion, and a rigid portion that is formed from a second material, which is harder than the first material, is provided at least at the rear-side cavity forming portion, such that a rigidity of the rear-side cavity forming portion is higher than a rigidity of the connecting portion.

2. The speaker according to claim 1, wherein:
the elastic portion is provided at an area that includes the open-side end portion of the holding portion; and
the open-side end portion of the holding portion includes a front-side contact portion that extends to an inner side of an opening of the holding member and that contacts a front-side outer peripheral portion of the speaker unit.

3. The speaker according to claim 1, wherein a rigidity reducing portion, which reduces the rigidity of the connecting portion in an axial direction of the speaker unit, is formed at the connecting portion.

4. The speaker according to claim 1, wherein:
the elastic portion is provided at an area that includes a portion that configures an inner surface side of the holding portion;
the inner surface side of the holding portion contacts an outer peripheral surface of the speaker unit; and
a portion at an outer surface side of the holding portion, with respect to a portion that configures the inner surface side of the holding portion, includes the rigid portion.

5. The speaker according to claim 1, wherein:
the elastic portion is provided at at least a portion that integrally configures the connecting portion of the attachment overhang portion and the holding portion;
the rigid portion is provided at a portion that integrally configures another part of the holding portion and the rear-side cavity forming portion; and
the elastic portion and the rigid portion are provided with concave-convex fitting portions that are formed in an axial direction of the speaker unit such that the concave-convex fitting portions fit together at boundary portions of the elastic portion and the rigid portion.

6. The speaker according to claim 1, wherein at least part of the affixed portion is formed from a material that is harder than the first material.

7. The speaker according to claim 1, wherein:
the rigid portion is provided at an area that includes at least part of the holding portion; and
an extension portion, which extends from a portion that configures the rigid portion at the holding portion and which is part of the rigid portion, is provided adjacent to the elastic portion at the attachment overhang portion.

8. The speaker according to claim 2, wherein a rigidity reducing portion, which reduces the rigidity of the connecting portion in an axial direction of the speaker unit, is formed at the connecting portion.

9. The speaker according to claim 2, wherein:
the elastic portion is provided at an area that includes a portion that configures an inner surface side of the holding portion;
the inner surface side of the holding portion contacts an outer peripheral surface of the speaker unit; and
a portion at an outer surface side of the holding portion, with respect to a portion that configures the inner surface side of the holding portion, includes the rigid portion.

10. The speaker according to claim 3, wherein:
the elastic portion is provided at an area that includes a portion that configures an inner surface side of the holding portion;
the inner surface side of the holding portion contacts an outer peripheral surface of the speaker unit; and
a portion at an outer surface side of the holding portion, with respect to a portion that configures the inner surface side of the holding portion, includes the rigid portion.

11. The speaker according to claim 2, wherein:
the elastic portion is provided at at least a portion that integrally configures the connecting portion of the attachment overhang portion and the holding portion;
the rigid portion is provided at a portion that integrally configures another part of the holding portion and the rear-side cavity forming portion; and
the elastic portion and the rigid portion are provided with concave-convex fitting portions that are formed in an axial direction of the speaker unit such that the concave-convex fitting portions fit together at boundary portions of the elastic portion and the rigid portion.

12. The speaker according to claim 3, wherein:
the elastic portion is provided at at least a portion that integrally configures the connecting portion of the attachment overhang portion and the holding portion;
the rigid portion is provided at a portion that integrally configures another part of the holding portion and the rear-side cavity forming portion; and
the elastic portion and the rigid portion are provided with concave-convex fitting portions that are formed in an axial direction of the speaker unit such that the concave-convex fitting portions fit together at boundary portions of the elastic portion and the rigid portion.

13. The speaker according to claim 4, wherein:
the elastic portion is provided at at least a portion that integrally configures the connecting portion of the attachment overhang portion and the holding portion;
the rigid portion is provided at a portion that integrally configures another part of the holding portion and the rear-side cavity forming portion; and
the elastic portion and the rigid portion are provided with concave-convex fitting portions that are formed in an axial direction of the speaker unit such that the concave-convex fitting portions fit together at boundary portions of the elastic portion and the rigid portion.

14. The speaker according to claim 2, wherein at least part of the affixed portion is formed from a material that is harder than the first material.

15. The speaker according to claim 3, wherein at least part of the affixed portion is formed from a material that is harder than the first material.

16. The speaker according to claim 4, wherein at least part of the affixed portion is formed from a material that is harder than the first material.

17. The speaker according to claim 2, wherein:
the rigid portion is provided at an area that includes at least part of the holding portion; and
an extension portion, which extends from a portion that configures the rigid portion at the holding portion and which is part of the rigid portion, is provided adjacent to the elastic portion at the attachment overhang portion.

18. The speaker according to claim 3, wherein:
the rigid portion is provided at an area that includes at least part of the holding portion; and
an extension portion, which extends from a portion that configures the rigid portion at the holding portion and which is part of the rigid portion, is provided adjacent to the elastic portion at the attachment overhang portion.

19. The speaker according to claim 4, wherein:
the rigid portion is provided at an area that includes at least part of the holding portion; and
an extension portion, which extends from a portion that configures the rigid portion at the holding portion and which is part of the rigid portion, is provided adjacent to the elastic portion at the attachment overhang portion.
